(19) United States
(12) Patent Application Publication
(10) Pub. No.: US 2004/0159475 A1
(43) Pub. Date: Aug. 19, 2004

(54) Vehicular powered tracks

(76) Inventor: Halley Ray Moor, JR., Hankamer, TX (US)

Correspondence Address: C. DALE QUISENBERRY, POLASEK, QUISENBERRY & ERRINGTON, L.L.P., 6750 West Loop South, Suite 920, Bellaire, TX, 77401, US

(21) Appl. No.: 10/411,919

(22) Filed: Apr. 11, 2003

Related U.S. Application Data
(63) Continuation-in-part of application No. 10/365,859, filed on Feb. 13, 2003.

(51) Int. Cl. B62D 55/00

(52) U.S. Cl. 180/9.44

(57) ABSTRACT

A vehicular driven track apparatus is provided that may include a left track assembly and a right track assembly. Each track assembly may include a drive member. At least one roller member may be in mechanical communication with the left and right drive members. A left steering pad may be operatively connected to the left drive member to control movement thereof, and a right steering pad may be operatively connected to the right drive member to control movement thereof. A left brake or motor may be operatively connected to the left steering pad and disposed to control transfer of rotational movement from the at least one roller member to the left drive member. A right brake or motor may be operatively connected to the right steering pad and disposed to control transfer of rotational movement from the at least one roller member to the right drive member. The left and right steering pads may be adapted to interact with a left and right front wheel of a vehicle such that the apparatus may be steered from inside the vehicle by turning the front wheels to turn the steering pads to control movement of the left and right drive members. The steering pads may also be adapted to movably engage the front tires of a four-wheel drive vehicle. Other embodiments are also provided in which the apparatus is steered through use of brake cables instead of through steering pads.

### RELATED APPLICATIONS

This application is a continuation-in-part of U.S. application Ser. No. 10/365,859, filed Feb. 13, 2003.

### BACKGROUND OF THE INVENTION

1. Field of the Invention

The present invention relates to a track apparatus that may be powered by a vehicle, and more specifically to a vehicle powered track apparatus that may be steered by turning the front wheels of the vehicle.

2. Description of the Related Art

It is not unusual for a vehicle—whether it be a car, truck, van, four-wheeler, etc.—to encounter terrain that cannot be navigated without becoming stuck. This may happen in a variety of environments and circumstances, such as by those in the construction industry, by farmers, off-road enthusiasts, or by hunters, just to name a few. For example, the terrain may be very wet, muddy, and/or uneven, or it may be covered in deep snow. The present invention is applicable and useful in situations where a vehicle would become stuck if driven into these or other types of terrain. Briefly, the present invention is directed to a track apparatus upon which the vehicle can be driven and then engaged with the vehicle. The track apparatus is then powered and steered by the vehicle. As will be seen below, once engaged with the track apparatus, the vehicle will be equipped to navigate terrain far more demanding than the vehicle could navigate by itself. Other features, aspects and advantages of the present invention will become apparent from the following discussion.

### SUMMARY OF THE INVENTION

In one aspect, the present invention may be a vehicular powered track apparatus comprising: a left track assembly and a right track assembly, the left track assembly having a left drive member, and the right track assembly having a right drive member; a left roller member connected to the left drive member, and a right roller member connected to the right drive member; and a left steering pad operatively connected to the left drive member to control movement thereof, and a right steering pad operatively connected to the right drive member to control movement thereof, each steering pad having an idler roller rotatably mounted thereto. Another feature of this aspect of the present invention may be that each steering pad further includes a pair of retention members. Another feature of this aspect of the present invention may be that each retention member includes a side wall roller member rotatably mounted thereto. Another feature of this aspect of the present invention may be that each retention member includes a fixed end attached to its corresponding steering pad and an unattached end, and each retention member extends upwardly away from its fixed end at an inclined angle. Another feature of this aspect of the present invention may be that the apparatus may further include a left brake operatively connected to the left steering pad and disposed to control transfer of rotational movement from the left roller member to the left drive member, and a right brake operatively connected to the right steering pad and disposed to control transfer of rotational movement from the right roller member to the right drive member. Another feature of this aspect of the present invention may be that the apparatus may further include a left motor operatively connected to the left steering pad and disposed to control transfer of rotational movement from the left roller member to the left drive member, and a right motor operatively connected to the right steering pad and disposed to control transfer of rotational movement from the right roller member to the right drive member. Another feature of this aspect of the present invention may be that the apparatus may further include at least one power generator connected to at least one of the left and right roller members, the power generator being in communication with at least one motor coupled to at least one of the left and right drive members.

In another aspect, the invention may be a vehicular powered track apparatus comprising: a left track assembly and a right track assembly, the left track assembly having a left drive member, and the right track assembly having a right drive member; a left motor connected to the left drive member, and a right motor connected to the right drive member; a left steering device operatively connected to a left control device, and a right steering device operatively connected to a right control device; and at least one power generator in communication with the left motor through the left control device and with the right motor through the right control device. Another feature of this aspect of the present invention may be that the left steering device is a left steering pad, and the right steering device is a right steering pad. Another feature of this aspect of the present invention may be that each steering pad includes an idler roller rotatably mounted thereto. Another feature of this aspect of the present invention may be that each steering pad further includes a pair of retention members, and each retention member includes a side wall roller member rotatably mounted thereto. Another feature of this aspect of the present invention may be that the left steering device is a left cable, and the right steering device is a right cable. Another feature of this aspect of the present invention may be that the left control device is a left brake, and the right control device is a right brake. Another feature of this aspect of the present invention may be that the left control device is a left valve, and the right control device is a right valve. Another feature of this aspect of the present invention may be that the power generator is a pump movably disposed in a track and adapted for releasable engagement with a power-take-off device. Another feature of this aspect of the present invention may be that the at least one power generator comprises a left and a right pump, the left pump being in communication with the left motor through the left control device and the right pump being in communication with the right motor through the right control device.

In another aspect, the invention may be a vehicular powered track apparatus comprising: a left track assembly and a right track assembly, the left track assembly having a left drive member, and the right track assembly having a right drive member; a left roller member connected to the left drive member, and a right roller member connected to the right drive member; and a left cable operatively connected to the left drive member to control movement thereof, and a right cable operatively connected to the right drive member to control movement thereof, the vehicle being positioned on the apparatus such that front tires of the vehicle are not in contact with any part the apparatus other than, if any contact, with a rotating part thereof. Another feature of this aspect of the present invention may be that the apparatus may further include a left brake operatively connected to the left cable and disposed to control transfer of rotational movement from the left roller member to the left drive member, and a right brake operatively connected to the right cable and disposed to control transfer of rotational movement from the right roller member to the right drive member. Another feature of this aspect of the present invention may be that the apparatus may further include a left motor operatively connected to the left cable and disposed to control transfer of rotational movement from the left roller member to the left drive member, and a right motor operatively connected to the right cable and disposed to control transfer of rotational movement from the right roller member to the right drive member. Another feature of this aspect of the present invention may be that the apparatus may further include at least one power generator connected to at least one of the left and right roller members, the at least one power generator being in communication with at least one of the left and right motors. Another feature of this aspect of the present invention may be that the left and right roller members are idler rollers.

In yet another aspect, the present invention may be a vehicular powered track apparatus comprising: a left track assembly and a right track assembly, the left track assembly having a left drive member, and the right track assembly having a right drive member; at least one power generator connected between a source of rotational power on the vehicle and the left and right drive members; and a connector disposed between at least one component of the vehicle and the at least one power generator such that a direction of movement of the apparatus is controlled by movement of the at least one component of the vehicle. Another feature of this aspect of the present invention may be that the at least one power generator is at least one of a pump and a roller member. Another feature of this aspect of the present invention may be that the source of rotational power is a wheel on the vehicle. Another feature of this aspect of the present invention may be that the rotational power is transferred from the wheel to the power generator through a roller member. Another feature of this aspect of the present invention may be that the apparatus may further include an idler roller member engaged with the wheel. Another feature of this aspect of the present invention may be that the apparatus may further include a final drive connected between the wheel and the at least one power generator. Another feature of this aspect of the present invention may be that the apparatus may further include a jacking device to raise the vehicle so that the only contact between the wheel and the apparatus is through the power generator. Another feature of this aspect of the present invention may be that the source of rotational power is a power-take-off on the vehicle. Another feature of this aspect of the present invention may be that the at least one component on the vehicle comprises the left front tire and the right front tire of the vehicle, and the connector comprises a left steering pad engageable with the left front tire and a right steering pad engageable with the right front tire. Another feature of this aspect of the present invention may be that the left steering pad is connected to a left control device adapted to control transmission of energy from the at least one power generator to a left motor connected to the left drive member, and the right steering pad is connected to a right control device adapted to control transmission of energy from the at least one power generator to a right motor connected to the right drive member. Another feature of this aspect of the present invention may be that the at least one component of the vehicle comprises a left brake lever and a right brake lever, and the connector comprises a left cable and a right cable, the left cable being connected between the left brake lever and a left control device adapted to control transmission of energy from the at least one power generator to the left drive member, and the right cable being connected between the right brake lever and a right control device adapted to control transmission of energy from the at least one power generator to the right drive member. Another feature of this aspect of the present invention may be that the at least one power generator is a pump movably disposed in a track. Another feature of this aspect of the present invention may be that the apparatus may further include a gear drive connected between a left roller member and a right roller member, and further being connected to a first pump and a second pump, the first pump being in communication with a left motor connected to the left drive member, and the second pump being in communication with a right motor connected to the right drive member.

In still another aspect, the present invention may be a vehicular powered track apparatus comprising: a left track assembly and a right track assembly, the left track assembly having a left drive member, and the right track assembly having a right drive member; means for transferring movement from a wheel of the vehicle to the left and right drive members; and means for controlling movement of the left and right drive members.

Other features and aspects of the present invention will be explained below.

### BRIEF DESCRIPTION OF THE DRAWINGS

FIG. 1 is a top view of a specific embodiment of the vehicle powered track apparatus of the present invention.

FIG. 2 is a side view of the track apparatus shown in FIG. 1, shown with a vehicle in phantom lines positioned thereon.

FIG. 3 is an end view taken from the rear of the apparatus as shown in FIG. 2.

FIG. 4 is a side view of the apparatus as shown in FIG. 1, shown in partial cross-section taken along line 4-4.

FIG. 5 is a side view in partial cross-section similar to FIG. 4, except that this view illustrates the apparatus with a single roller member in contact with the rear drive wheel of the vehicle as opposed to the belt disposed about multiple rollers shown in FIGS. 1-4.

FIG. 6 is a perspective view showing an alternative arrangement for a brake in relation to a drive axle and steering pad.

FIG. 7 is a perspective view of an alternative arrangement for the braking and steering feature of a specific embodiment of the present invention.

FIG. 7A is a perspective view similar to FIG. 7 but showing the brake positioned in a different location.

FIG. 8 is a top view of another alternative arrangement for the braking and steering feature of the present invention, this embodiment being directed to a brake fluid actuator and a fluid-actuated brake.

FIG. 9 is a top view of an alternative embodiment of the track apparatus of the present invention.

FIG. 10 is an end view from the rear of the apparatus showing an alternative embodiment of the present invention.

FIG. 11 is an end view similar to FIG. 10, only FIG. 11 is an end view of the front of the alternative embodiment of the apparatus shown in FIG. 11.

FIG. 12 is a top view of another embodiment of the apparatus of the present invention, this one using hydraulic motors as opposed to mechanical brakes to steer the apparatus.

FIG. 13 is top view of yet another embodiment of the apparatus of the present invention, this one being to similar the apparatus shown in FIG. 12, with a main difference being that the embodiment of FIG. 13 is shown with a single belt that may span most of the width of the apparatus such that both rear tires of the vehicle may rest thereon.

FIG. 14 is a perspective view showing an alternative embodiment of a track assembly of the present invention, this one including a pontoon to enable the apparatus to float.

FIG. 15 is a top view of an alternative embodiment of the present invention in which the steering pads have been modified to accommodate a four-wheel drive vehicle.

FIG. 16 is a side view of the embodiment shown in FIG. 15, and shows a four-wheeler positioned thereon.

FIG. 17 is a perspective view showing the modified steering pad shown in FIGS. 15 and 16, but connected to an alternative brake/axle arrangement similar to that shown in FIG. 7A.

FIG. 18 is top view of another alternative embodiment of the present invention, which combines the modified steering pads as shown in FIGS. 15-17 with portions of the hydraulically-operated embodiments of FIGS. 12 and 13.

FIG. 19 is a perspective view of a portion of the embodiment shown in FIG. 18, and further illustrates a movable hydraulic pump that is removably engageable with a power-take-off device on a vehicle, such as a four-wheeler.

FIG. 20 is a perspective view similar to FIG. 19, and illustrates the moveable pump being engageable with a rear drive wheel of the vehicle.

FIG. 21 is a top view of another hydraulically-operated embodiment of the present invention.

FIG. 22 is a top view of yet another hydraulically-operated embodiment of the present invention, this one including two power generators connected to two separate outputs of the gear drive.

FIG. 23 is a top view similar to FIG. 22, and shows yet another hydraulically-operated embodiment of the present invention, this one with the motors and associated drive members situated towards the rear of the track apparatus.

FIG. 24 is an end view from the rear of one embodiment of the apparatus of the present invention.

FIG. 25 is a side view of another embodiment of the present invention in which the apparatus is steered through brake cables instead of steering pads.

FIG. 26 is a front view of the embodiment shown in FIG. 25.

FIG. 27 is a side view of another embodiment of the present invention in which the apparatus is steered through brake cables instead of steering pads, and power is hydraulically transferred from a vehicle to one or more pumps to power motors that are connected to the track assemblies.

FIG. 28 is a front view of the embodiment shown in FIG. 27.

FIG. 29 is a side view showing the apparatus of the present invention with its transmission shifted to a neutral position and being towed by a vehicle.

FIG. 30 is a side view similar to FIG. 29, but further including a retractable towing wheel assembly lowered into a towing position.

FIG. 31 is a side view of the apparatus of the present invention and illustrates a parking brake.

While the invention will be described in connection with the preferred embodiments, it will be understood that it is not intended to limit the invention to those embodiments. On the contrary, it is intended to cover all alternatives, modifications, and equivalents as may be included within the spirit and scope of the invention as defined by the appended claims.

### DETAILED DESCRIPTION OF THE INVENTION

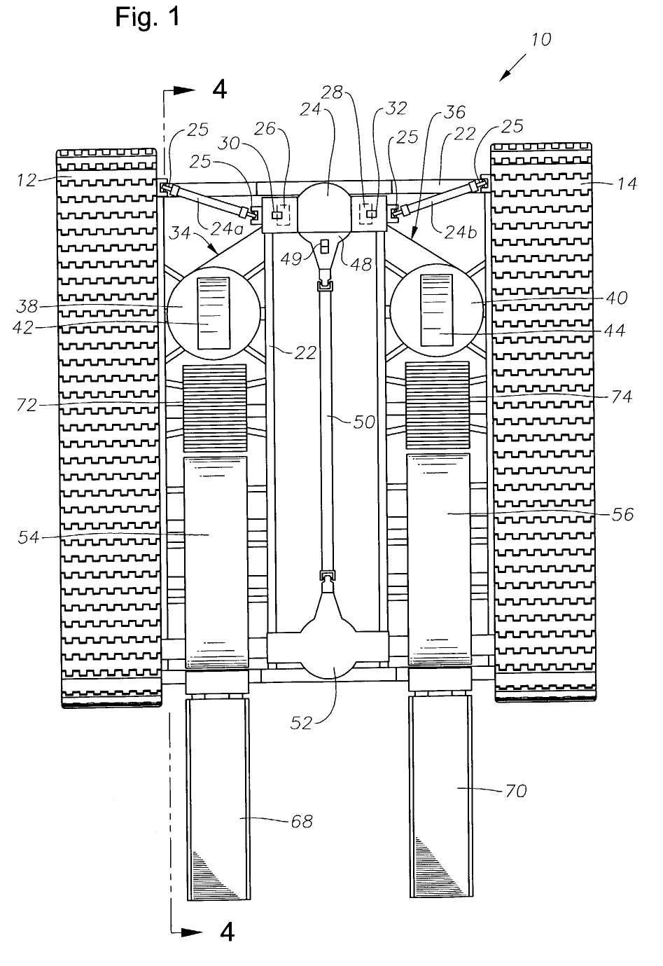

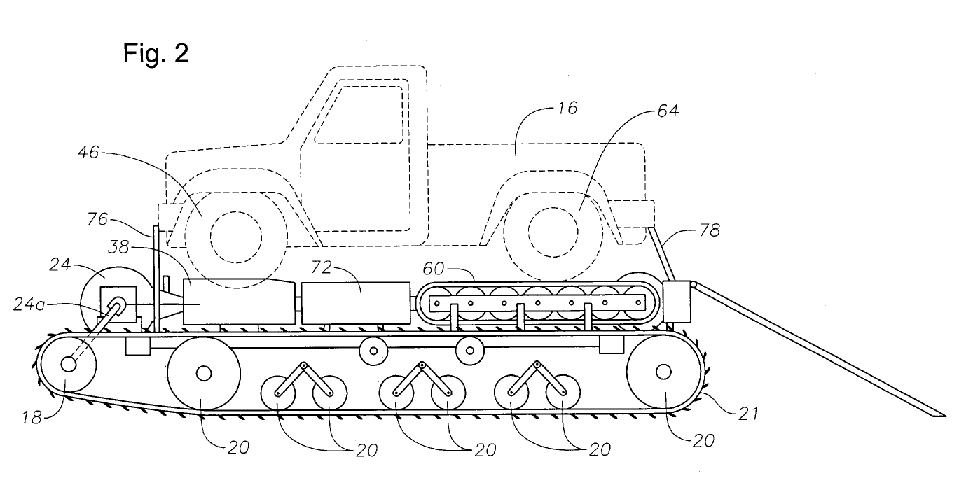

Referring to the drawings in detail, wherein like numerals denote identical elements throughout the several views, there is shown in FIG. 1 a top view of a specific embodiment of a vehicular driven track apparatus 10 constructed in accordance with the present invention. In a specific embodiment, the track apparatus 10 may include a left track assembly 12 and a right track assembly 14. As shown in FIG. 2, which is a side view of the apparatus 10 as shown in FIG. 1 but shown with a vehicle 16 mounted thereon in phantom lines, each track assembly 14 may be of any type of track assembly known in the art, and may include a drive member 18 (e.g., a sprocket), a number of idler members 20, and a continuous traction belt 21 disposed therearound. Referring again to FIG. 1, the left and right track assemblies 12 and 14 may be connected to a frame 22. The apparatus 10 may further include a drive axle 24 connected, either directly or indirectly, to each of the drive members 18 of the left and right track assemblies 12 and 14. In a specific embodiment, the drive axle 24 may be connected to the drive members 18 of the left and right track assemblies 12 and 14 through a left axle shaft 24a and a right axle shaft 24b, respectively. Each axle shaft 24a and 24b may include a U-joint 25 at each end thereof for connecting the axle shafts 24a and 24b between the drive axle 24 and the drive members 18. The drive axle 24 may be of any type known to those of skill in the art. In a specific embodiment, the drive axle 24 may be of the type that includes a left brake 26 and a right brake 28, each of which is shown in phantom as being mounted within the drive axle 24. The left brake 26 may include an actuator member 30 and the right brake 28 may include an actuator member 32.

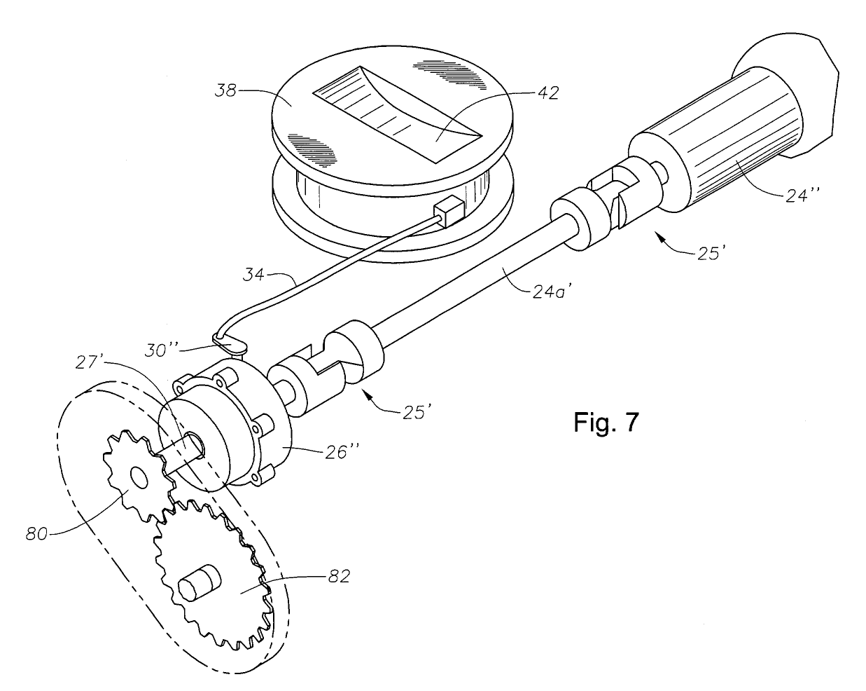

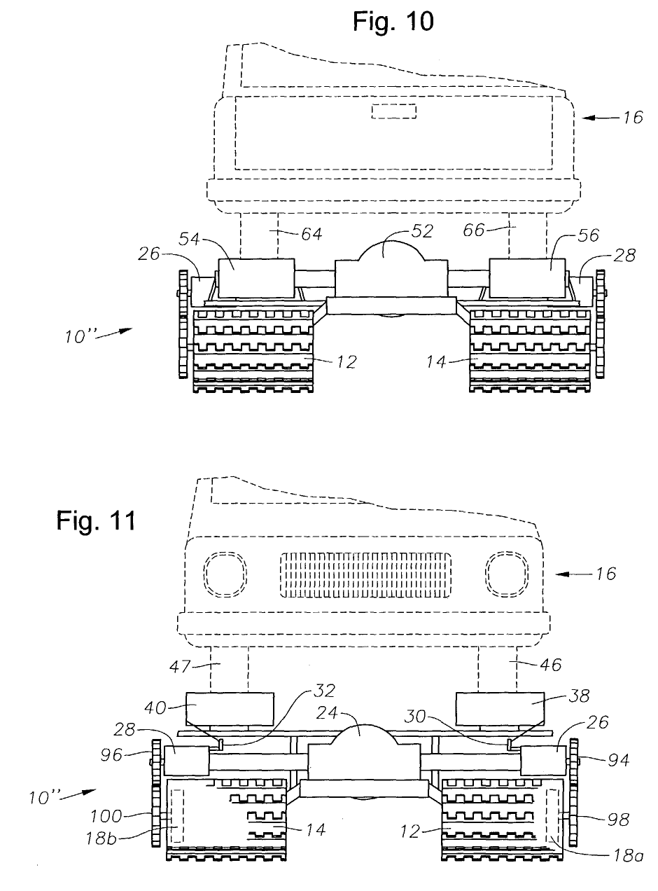

The invention is not limited to any particular type of brake but is intended to encompass all types of brakes known to those of ordinary skill in the art, including but not limited to disc brakes, drum brakes, power brakes, etc. Similarly, the scope of the invention is not limited to the specific location of the brakes, other than to have one located on each side of the apparatus 10 and be mechanically connected, whether directly or indirectly, to the corresponding drive member 18 of the track assemblies 12 and 14, so as to restrict the transfer of rotational movement from the drive axle 24 to the drive members 18 upon actuation of the corresponding brake. For example, in specific embodiments as shown in FIGS. 6 and 11, the brakes may be separate from the drive axle 24 and coupled proximate the drive members 18.

Referring again to FIG. 1, the apparatus 10 may further include a left steering connector 34 connected between the actuator member 30 of the left brake 26 and a left steering pad 38. The apparatus 10 may further include a right steering connector 36 connected between the actuator member 32 of the right brake 28 and a right steering pad 40. In a specific embodiment, the left and right steering connectors 34 and 36 may each be a cable. As shown in FIG. 4, which is a cross-sectional side view taken along line 4-4 of FIG. 1, each steering pad 38 and 40 is rotatably mounted to the frame 22, such as on a bearing member 39. As shown in FIGS. 1 and 4, in a specific embodiment, each steering pad 38 and 40 may include a tire trough 42/44 adapted to receive a front left tire 46 and a front right tire 47 (see FIG. 11), respectively, of the vehicle 16. As more fully explained below, the apparatus 10 may be steered from inside the vehicle 16 by turning the front tires of the vehicle 16.

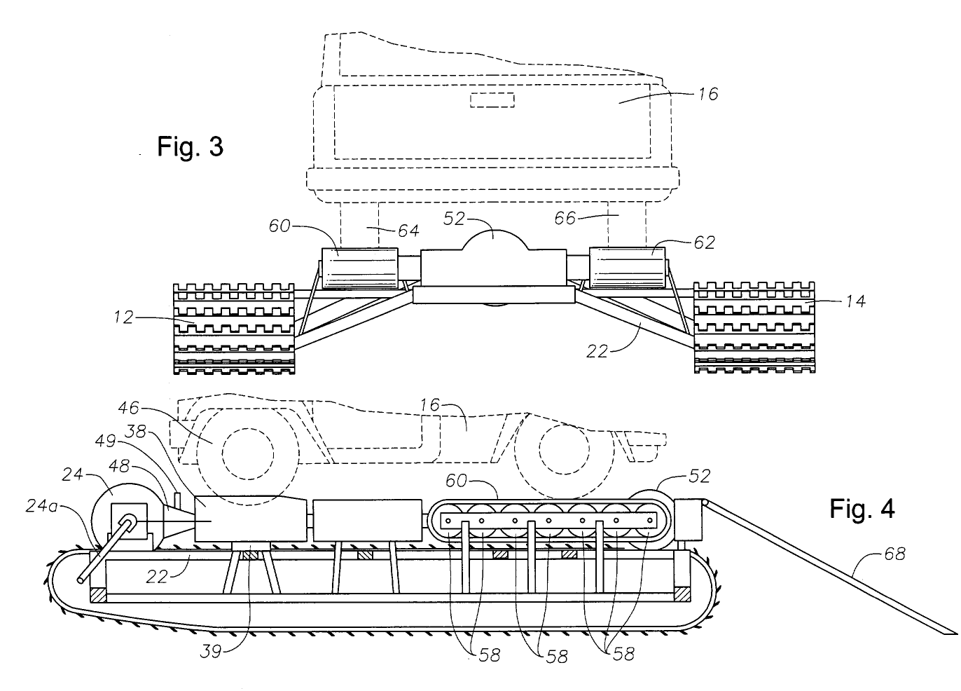

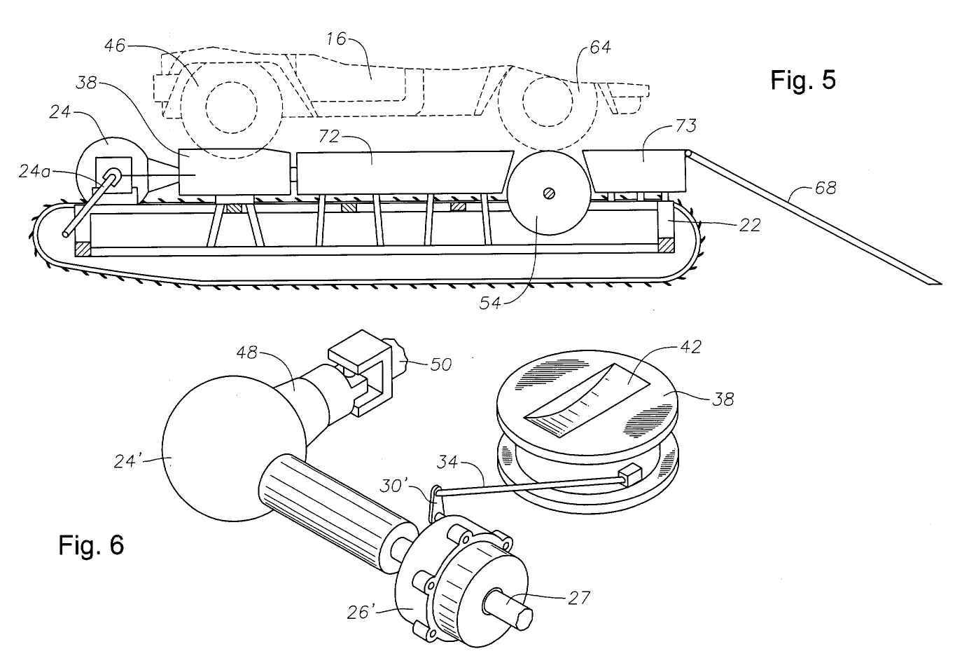

As shown in FIG. 1, the apparatus 10 may further include a transmission 48 which may include a gear shift member 49. In a specific embodiment, the transmission 48 may be connected to the drive axle 24 in any manner known to those of skill in the art. The apparatus 10 may further include a drive shaft 50 connected between the transmission 48 and a gear drive 52, which may be located towards the rear of the apparatus 10. It will be understood that the apparatus 10 may be provided without a transmission 24, in which case the drive shaft 50 would be connected to the drive axle 24. In a specific embodiment, the gear drive 52 may be of the type found in the rear end of any car or truck. A left side of the gear drive 52 may be connected to a left roller member 54, and a right side of the gear drive 52 may be connected to a right roller member 56. The left and right roller members 54 and 56 are connected to the frame 22. In a specific embodiment, the left and right roller members 54 and 56 may each be a single roller, as shown in FIG. 5. In the embodiment of FIG. 5, the apparatus 10 may include a left rear bridge 73 and a right rear bridge. In another specific embodiment, as shown in FIGS. 1, 2 and 4, the left and right roller members 54 and 56 may include a number of rollers 58, one (on each side of the apparatus 10) of which may be connected to the gear drive 52. In this embodiment, the left and right roller members 54 and 56 may further include a left belt 60 and a right belt 62 (see, e.g., FIGS. 2 and 3). The left and right roller members 54 and 56 are adapted for engagement with left and right rear drive wheels 64 and 66 (see FIG. 3) of the vehicle 16. By providing the apparatus 10 with the belt-drive roller members 54 and 56 as shown in FIGS. 1-4, as opposed to a single roller as shown in FIG. 5, the apparatus 10 is capable of being powered by many different vehicles having a variety of lengths and wheel bases without making any modifications to the apparatus 10.

The apparatus 10 may further include a left ramp 68 and a right ramp 70, as shown in FIG. 1, each of which may be hingedly attached to the frame 22 in a specific embodiment. As also shown in FIG. 1, the apparatus 10 may include a left bridge member 72 mounted to the frame 22 and positioned between the left steering pad 38 and the left roller member 54. Similarly, the apparatus 10 may include a right bridge member 74 mounted to the frame 22 and positioned between the right steering pad 40 and the right roller member 56.

In operation, the vehicle 16 is driven up the ramps 68 and 70 and over the left and right roller members 54 and 56 and the left and right bridge members 72 and 74 until the front tires of the vehicle 16 come to rest on the left and right steering pads 38 and 40 (such as in tire troughs 42 and 44), and the rear tires of the vehicle 16 come to rest on the left and right roller members 54 and 56. The vehicle 16 may then be secured to the apparatus 10 by, for example, front and/or rear vehicle connectors 76 and 78 (see FIG. 2). The driver of the vehicle 16 may then drive the apparatus 10 in the same manner as the vehicle 16 is driven. For example, the vehicle 16 is placed in gear, and the accelerator is depressed to cause the rear tires 64 and 66 to turn. This causes the roller members 54/56 to turn, which causes the gear drive 52 to turn, which causes the drive shaft 50 to turn, which causes the transmission 48 and drive axle 24 to turn, which causes the left and right track assemblies 12 and 14 to turn. If it is desired to turn the apparatus 10, the steering wheel (not shown) of the vehicle 16 is turned in the direction desired, and the apparatus 10 will turn in that direction. In this specific embodiment, the turning takes place through interaction of the steering pads 38 and 40 and the brakes 26 and 28, as will now be explained in more detail.

If, for example, it is desired to turn to the left, then the steering wheel (not shown) of the vehicle 16 is turned to the left. This causes both steering pads 38 and 40 to rotate in a counterclockwise direction. This will cause the left steering connector 34 to shift the actuator member 30 on the left brake 26 so as to actuate the brake 26 and thereby prevent power from being transferred to the left track assembly 12. The connectors 34 and 36 are configured so that turning the steering pads 38 and 40 counterclockwise will actuate the left brake 26 but not the right brake 28, and turning the steering pads 38 and 40 clockwise will actuate the right brake 28 but not the left brake 26. In a specific embodiment, this may be accomplished by using cables as the connectors 34/36, and by connecting the left cable 34 to a point on the upper left (northwest) quadrant of the left steering pad 38 and by connecting the right cable 36 to a point on the upper right (northeast) quadrant of the right steering pad 40. In this manner, when the pads 38/40 are turned counterclockwise, the left cable 34 will pull the left brake actuator 30 to actuate the left brake 26, and the right cable 36 will become slack and not actuate the right brake 28. The same mode of operation holds true in reverse when the pads 38/40 are turned clockwise.

As mentioned above, FIG. 6 illustrates an alternative arrangement and relationship of the left brake 26′, drive axle 24′ and left steering pad 30. In this embodiment, instead of providing a drive axle 24 with a brake 26 housed therein, the brake 26′ is provided separately from the drive axle 24′ and is connected thereto. The brake 26′ includes an actuator member 30′ that is connected to the left steering pad 38 by the left steering connector 34. The brake 26′ may also include an output shaft 27 which may be connected directly or indirectly to the drive member 18 of the corresponding track assembly 12 or 14 in any manner known to those of skill in the art, including, for example, as shown in FIGS. 7 and 11, discussed below.

Another alternative braking arrangement similar to that shown in FIG. 6 is shown in FIG. 7, in which a left axle shaft 24a′ is connected between the brake 26″ and the drive axle 24″, such as via U-joints 25′. The brake 26″ includes a brake actuator 30″ that is connected to the left steering pad 38 by a left steering connector 34. The brake 26″ may further include an output shaft 27′ connected to a first gear 80 that is meshed with an optional second gear 82. The gear 80 and, if provided, the gear 82 may be part of the left track assembly 12 (FIG. 1). In a specific embodiment, the first gear 80 or the second gear 82 may comprise the drive member 18 in the track assembly 12 or 14. Alternatively, the second gear 82 may be coupled to the drive member 18 in a manner known to those of skill in the art. It will be understood that the configuration depicted in FIG. 7 is also provided on the right side of the apparatus. A variation of the embodiment shown in FIG. 7 is shown in FIG. 7A, in which the left brake 26″ is connected between the drive axle 24″ and the left axle shaft 24a′, and the left axle shaft 24a′ is connected to the gear 80.

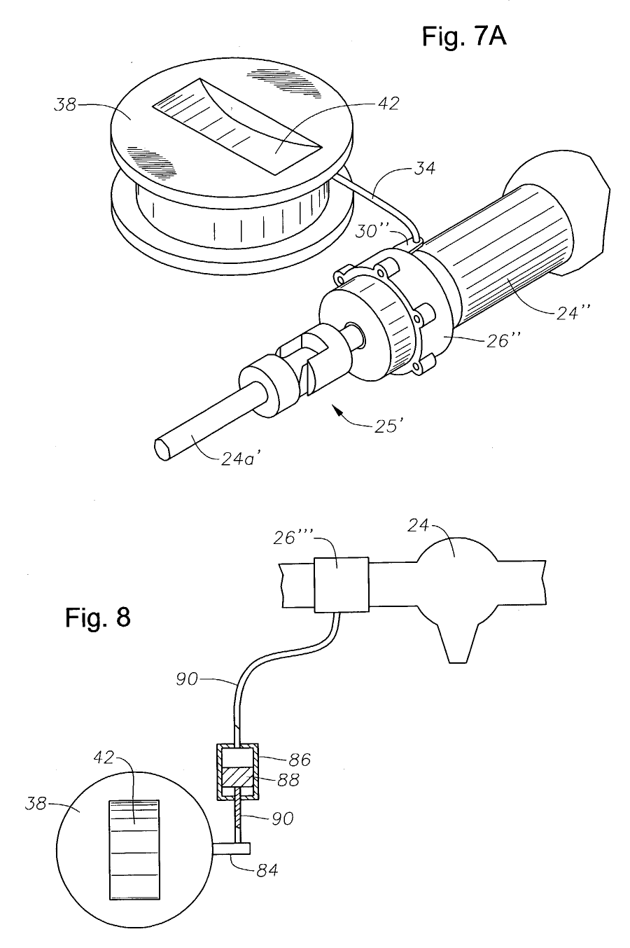

As mentioned above, the present invention is not limited to use with any particular type of brake. In another embodiment, as shown in FIG. 8, the track apparatus may be provided with a fluid-actuated brake 26′″ that may positioned in any of the positions in relation to the drive axle 24 discussed above in connection with any of the other embodiments. In this embodiment, the left steering pad 38 may include an arm 84 adapted for engagement with a brake fluid actuator 86 of any type known to those of skill in the art. In a specific embodiment, as shown in FIG. 8, the brake fluid actuator 86 may include a piston 88 sealably disposed for movement within the actuator 86. The piston 88 may include a plunger 90 extending therefrom and adapted for engagement with the arm 84 on the left steering pad 38. A fluid conduit 90 (such as a hose) is connected between the actuator 86 and the brake 26′″ such that movement of the piston 88 will operate to apply and withdraw pressurized fluid to and from the brake 26′″. In this manner, as known to those of skill in the art, the brake 26′″ will be actuated upon application of pressurized fluid thereto so as to apply a braking force to the left track assembly 12. In like manner, braking force will be removed from the left track assembly 12 upon withdrawal of pressurized fluid from the brake 26′″. In operation, when it is desired to turn the track apparatus to the left, the front tires of the vehicle 16 will be turned to the left (recall discussion in relation to FIGS. 1-3), which will cause the arm 84 on the left steering pad 38 to move the plunger 90, which will move the piston 88, which will actuate the brake 26′″ in the manner discussed above and thereby apply a braking force to the left track assembly 12. This will cause the apparatus to turn to the left under the force of the right track assembly 14, in the same manner as with the previously-discussed embodiments. It will be understood that the configuration depicted in FIG. 8 may also be provided on the right side of the apparatus.

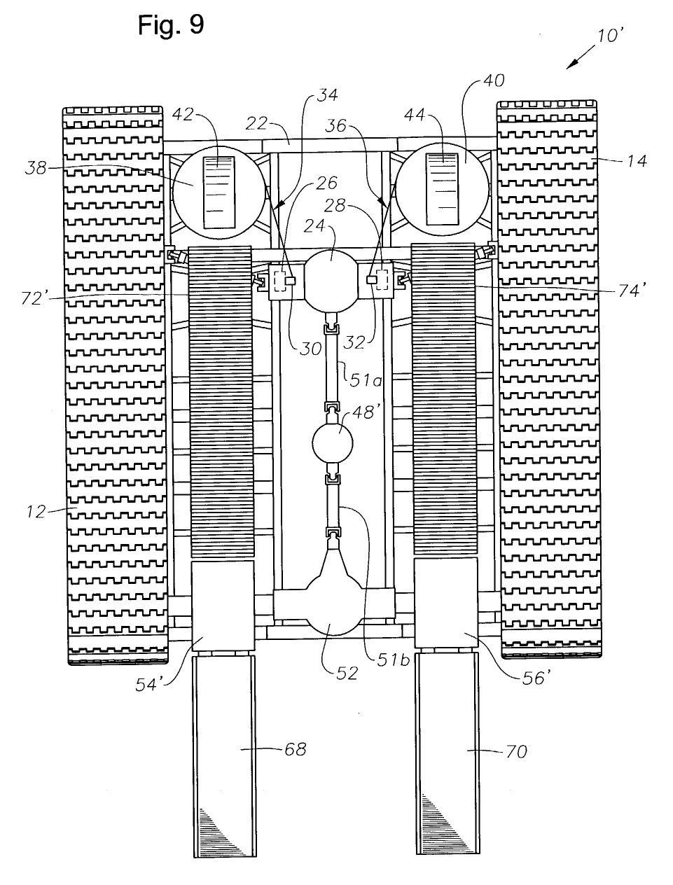

Referring now to FIG. 9, which shows another specific embodiment of the track apparatus of the invention, the steering pads 38 and 40 may be positioned forward of the drive axle 24. In this embodiment, the left steering connector 34 may be connected to the right side of the left steering pad 38, and the right steering connector 36 may be connected to the left side of the right steering pad 40. Another difference in this embodiment is that, instead of a single drive shaft 50 extending from the drive axle 24 or transmission 48 to the gear drive 52 as in FIG. 1, the apparatus 10′ may be provided with a transmission 48′ disposed approximately equidistant between the drive axle 24 and the gear drive 52. In this embodiment, the apparatus 10′ may further be provided with a forward drive shaft 51a connected between the drive axle 24 and the transmission 48′, and a rear drive shaft 51b connected between the transmission 48′ and the gear drive 52. This embodiment further illustrates that, in a specific embodiment, the bridges 72′ and 74′ may be longer than the bridges 72 and 74 in FIG. 1, and the roller members 54′ and 56′ may be shorter than the roller members 54 and 56 in FIG. 1. The mode of operation and the other structural components of this embodiment are essentially the same as explained above in connection with the embodiment shown in FIG. 1.

In another embodiment, as shown in FIGS. 10 and 11, the apparatus 10″ may be configured so that the tires of the vehicle 16, the left and right steering pads 38 and 40, and the left and right roller members 54 and 56 are positioned substantially directly above the left and right track assemblies 12 and 14, respectively. The structure and operation of this embodiment is very similar to the structure and operation of the embodiments shown in FIGS. 1 and 9, with the key difference being that rotational power from the drive axle 24 is delivered to the track assemblies 12 and 14 from the exterior sides of the track assemblies 12 and 14 as opposed to from their interior sides, as with the previously-discussed embodiments. As best shown in FIG. 11, this is accomplished by extending opposed ends of the drive axle 24 above the left and right track assemblies 12 and 14 and connecting the left end of the drive axle 24 to a first left gear 94 and connecting the right end of the drive axle 24 to a first right gear 96. The first left gear 94 is coupled to a second left gear 98, which in turn is coupled to the drive member 18a on the left track assembly 12. Similarly, the first right gear 96 is coupled to a second right gear 100, which in turn is coupled to the drive member 18b on the right track assembly 14. A left brake 26 is provided on the left side of the apparatus 10″, and a right brake 28 is provided on the right side of the apparatus 10″. The brakes 26 and 28 may be located in any position discussed above in relation to the drive axle 24. In a specific embodiment, as shown in FIG. 11, the brakes 26 and 28 may be located proximate the first left gear 94 and first right gear 96, respectively. The brakes 26 and 28 are connected to and controlled by movement of the left and right steering pads 38 and 40 in the same manner as discussed above in connection with previously-discussed embodiments of the present invention.

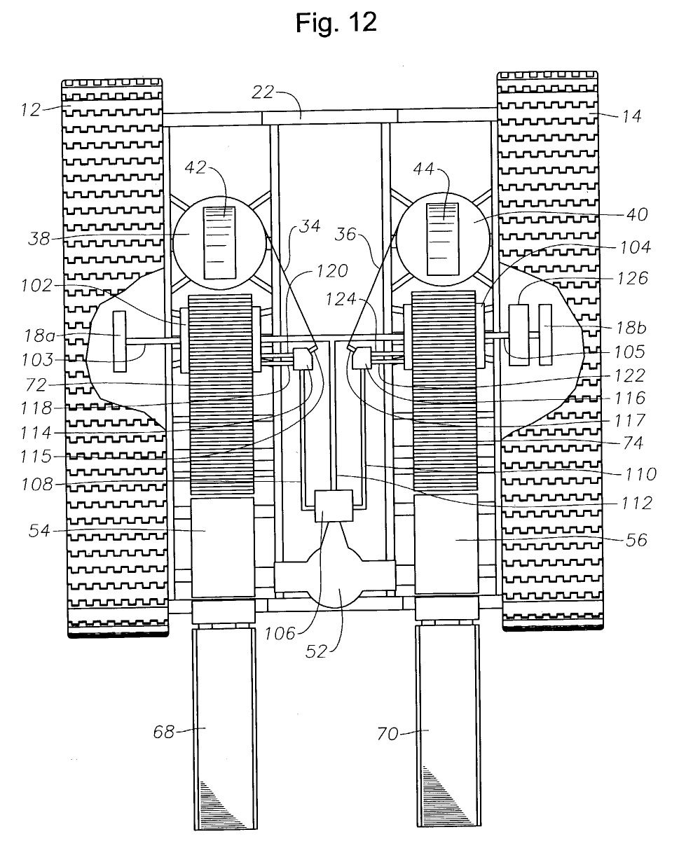

Referring now to FIG. 12, which illustrates another embodiment of the present invention, there is shown a track apparatus 10′″ that uses the left and right steering pads 38 and 40 to control a left and a right hydraulic motor 102 and 104, respectively, as opposed to controlling brakes as in the previously-discussed embodiments. The left motor 102 may include a left output shaft 103 that is connected to the left drive member 18a in the left track assembly 12. The right motor 104 may include a right output shaft 105 that may be connected through a final drive gear 126 to the right drive member 18b in the right track assembly 14. If desired, the left side of the apparatus 10′″ may also include a final drive gear between the left motor 102 and the left drive member 18a.

The embodiment of FIG. 12 does not include a drive axle 24 or a drive shaft 50 like the previously-discussed embodiments. Rather, the apparatus 10′″ includes a power generator 106, such as a hydraulic oil pump, that is coupled to the gear drive 52. The power generator 106 may be a hydraulic pump of the type having a fluid reservoir, as will be understood by those of skill in the art. The manner in which the gear drive 52 is actuated through the roller members 54 and 56 (and the structure of the roller members 54 and 56) may be as in any of the previously-discussed embodiments. It will be understood that the output of the gear drive 52 powers the power generator 106. In a specific embodiment in which the power generator 106 is a hydraulic pump, the pump 106 may include two high pressure outlet ports, one connected to a left high pressure conduit 108 and the other connected to a right high pressure conduit 110. The pump 106 may also include a return fluid port that is connected to a return conduit 112. The return conduit 112 is connected to a return fluid port on the left motor 102 and to a return fluid port on the right motor 104. The left high pressure conduit 108 is connected between the pump 106 and a left control device 114, such as a valve. The right high pressure conduit 110 is connected between the pump 106 and a right control device 116, such as a valve. A left forward conduit 118 is connected between the left control device 114 and the left motor 102, and a left reverse conduit 120 is connected between the left control device 114 and the left motor 102. A right forward conduit 122 is connected between the right control device 116 and the right motor 104, and a right reverse conduit 124 is connected between the right control device 116 and the right motor 104. In a specific embodiment, the conduits 108, 110, 112, 118, 120, 122, and 124 may each be a hydraulic hose, or, in another specific embodiment may each singly or in combination be a communication link of any type that is capable of being used to communicate signals of any type between the power generator 106 and the motors 102 and 104. The left control device 114 may include a left actuator member 115, and the right control device 116 may include a right actuator member 117. Each actuator member 115 and 117 may include a “forward” position and a “reverse” position, as will be understood by those skilled in the art. The left actuator member 115 is connected to the left steering pad 38 by a connector 34, and the right actuator member 117 is connected to the right steering pad 40 by a connector 36. The actuators 115 and 117 are connected to the steering pads 38 and 40 in such a way that the actuators 115 and 117 are in their “forward” positions when the steering pads 38 and 40 are positioned with the tire troughs 42 and 44 pointing straight ahead (i.e., parallel to the track assemblies 12 and 14). Similar to the manner in which the brakes of the previously-discussed embodiments are controlled by the steering pads 38 and 40, the steering pads 38 and 40 in this embodiment are adapted to operate the left and right control devices 114 and 116. The manner of operation of the embodiment of FIG. 12 will now be explained.

In operating the embodiment of FIG. 12, the vehicle 16 is driven up onto and positioned on the apparatus 10′″ in the same manner as discussed above, with the vehicle's rear tires on the roller members 54 and 56, and the vehicle's front tires on the steering pads 38 and 40. When the rear wheels start turning, the gear drive 52 will start turning, which will actuate the pump 106. This will cause pressurized fluid to start flowing out of the pump 106 through the left and right high pressure conduits 108 and 110 and to the left and right control devices (e.g., valves) 114 and 116, respectively. So long as the vehicle's tires are pointing straight ahead, so that the steering pads 38 and 40 have not been turned but are also pointing straight ahead, the actuator members 115 and 117 will remain in their “forward” positions, which will allow the pressurized fluid to pass through the motors 102 and 104 and through the return conduit 112 to the pump 106. With pressurized fluid flowing through the motors 102 and 104, the output shafts 103 and 105 and drive members 18 will turn and drive the track assemblies 12 and 14 forward. If it is desired to turn to the left, for example, the vehicle's front tires will be turned to the left, which will rotate the steering pads 38 and 40 to the left. This will cause the right steering pad connector 36 to go slack (in an embodiment where it is a cable), and the left steering pad connector 34 to shift the left actuator member 115 from its “forward” position to its “reverse” position. This will cause the left motor 102 to either lock and not turn at all or start turning in an opposite direction, so as to cause the shaft 103 and drive member 18a to rotate in a reverse direction. In this latter instance, it will be understood that the apparatus 10′″ will basically pivot about its center point, as the right track assembly 14 will be going forward at the same time the left track assembly 12 is going backward. When the tires are straightened up, the left actuator member 115 will be shifted back to its “forward” position and the track apparatus 10′″ will continue moving in the forward direction. It is noted that the present invention is not limited to any particular type of motor 102 or 104 or power generator 106.

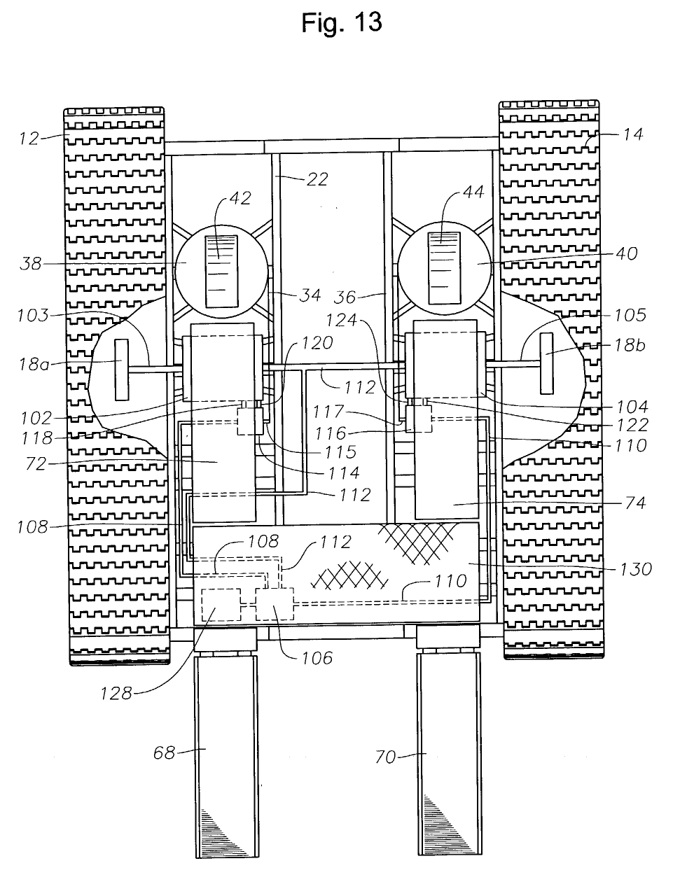

FIG. 13 illustrates another embodiment of the present invention, which is similar to the embodiment disclosed in FIG. 12, except that the embodiment of FIG. 13 does not include a gear drive 52 to transfer power to the pump 106. Instead, in this embodiment, the pump 106 is coupled directly to and driven by a roller member 128. In this embodiment, a drive belt 130 may be disposed around the roller member 128 and a number of idler rollers (such as idlers 58 of the embodiment shown in FIG. 4). In a specific embodiment, the drive belt 130 may be sufficiently wide to receive both rear wheels of the vehicle 16 (not shown in FIG. 13) The remaining components of this embodiment and the manner in which they operate are substantially as set forth above in connection with FIG. 12.

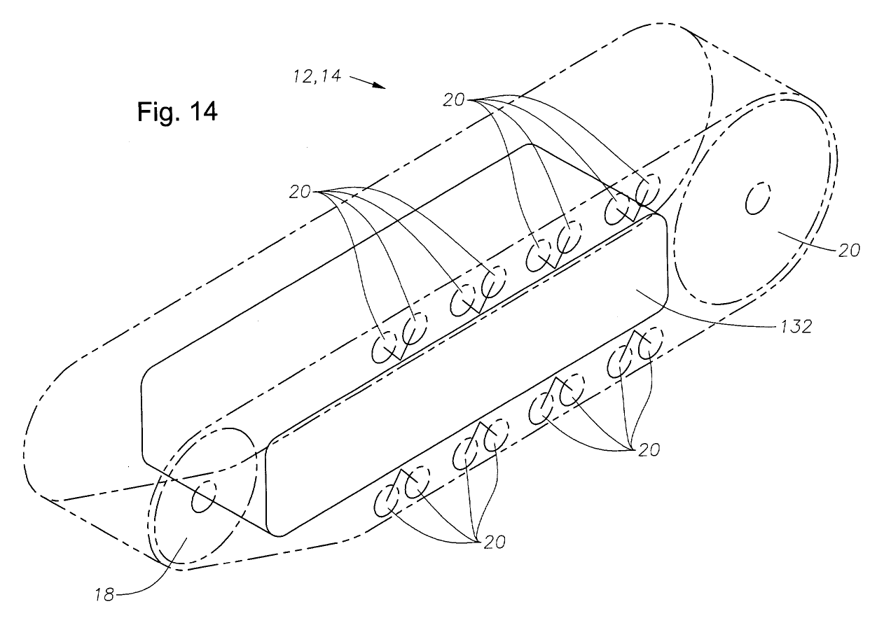

In another specific embodiment, the track assemblies 12 and 14 of the present invention may be provided with a pontoon 132, as shown in FIG. 14. In this manner, the track apparatus of the present invention may be adapted to float, so as to enable the apparatus to ferry the vehicle 16 across a body of water.

The present invention may also be adapted for use with four-wheel drive vehicles, such as full-time four-wheel drive trucks or SUVs, or All Terrain Vehicles (“ATVs” or “four-wheelers”). While the following description is generally provided in the context of four-wheelers, the various aspects and features of various embodiments that are described below are not necessarily intended to be limited to use with four-wheelers or any other four-wheel drive vehicles, but in certain circumstances may also be used with two-wheel drive vehicles.

In one aspect, for the invention to work with a four-wheel drive vehicle, the steering pads 42 may be modified to accommodate the fact that the front tires of a four-wheel drive vehicle are spinning at the same time it is desired to use them to turn the track apparatus 10.

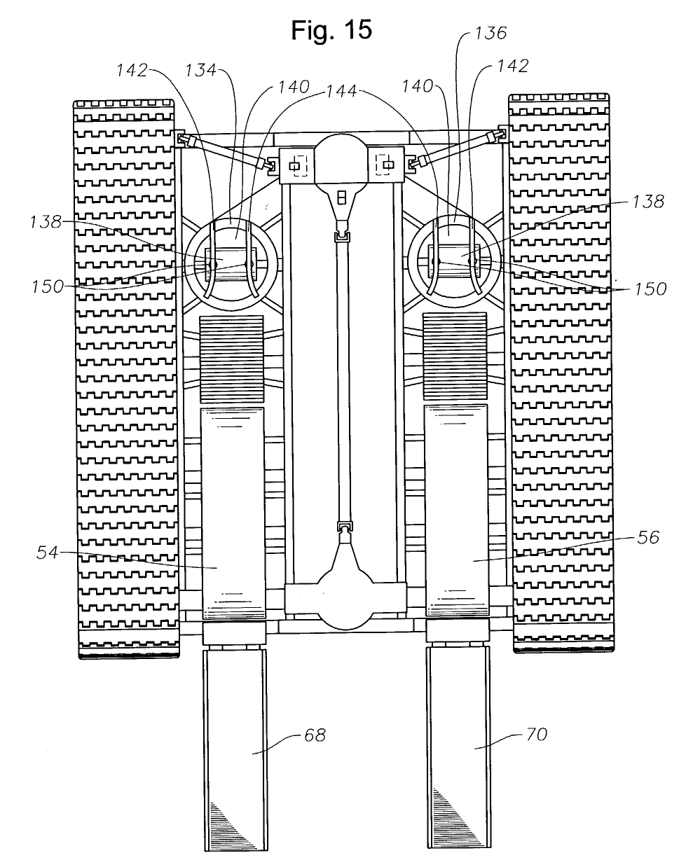

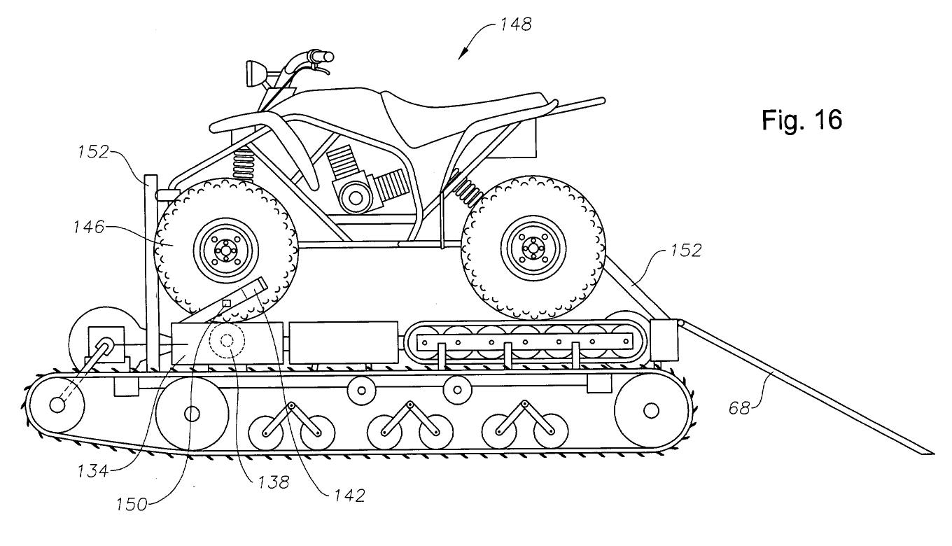

In one specific embodiment, as shown in FIGS. 15-17, the steering pads 134 and 136 may be mounted to the frame 22 in the same manner as discussed above. Each steering pad 134/136 may further include an idler roller 138 rotatably mounted within a recess 140 in the pad 134/136, and a pair of retaining members 142 and 144 extending upwardly away from the pad 134/136 at an inclined angle. Each retaining member 142/144 may include a fixed end attached to the pad 134/136 and a free or unattached end that may be slightly curved so as to guide the front wheel (e.g., 146) of a four-wheel drive vehicle, such as the four-wheeler 148 shown in FIG. 16, on to the idler roller 138. Each retaining member 142/144 may further include a side wall roller member 150 rotatably mounted therein and adapted for rolling engagement with a sidewall of a corresponding front tire (e.g., 146) of the four-wheeler 148 to prevent the tire from rubbing against the retaining member 142/144. The remaining aspects of this embodiment are as set forth above in connection with the embodiment shown in FIG. 1. It is to be understood that this aspect of the present invention may be employed with any of the various embodiments discussed above. For example, as shown in FIG. 17, this aspect of the invention may be used in conjunction with a brake/axle arrangement similar to that illustrated in FIG. 7A.

In use, the four-wheeler is driven up the ramps 68 and 70 and on to the track apparatus such that the rear tires are resting on the roller members 54 and 56, and the front tires are resting on the steering pads 134 and 136, specifically on top of the rollers 138 and between the corresponding retaining members 142. The four-wheeler 148 is then secured to the track apparatus by attachment members 152 (see FIG. 16). When the four-wheeler 148 is powered on and its wheels start turning, the rear tires will cause the track apparatus to start moving (in the same manner as discussed above in connection with other embodiments), and the rotation of the front tires will be transferred to the idler rollers 138. The front tires may also roll against the side wall roller members 150 as the front tires turn on the idler rollers 138. When the handlebars of the four-wheeler 148 are turned to turn the front tires to turn the track apparatus (in the same manner as explained above), the front tires will push against the corresponding side wall roller members 150 on the retaining members 142/144 and thereby turn the steering pads 134/136 to turn the track apparatus in the same manner as discussed hereinabove with respect to the other embodiments.

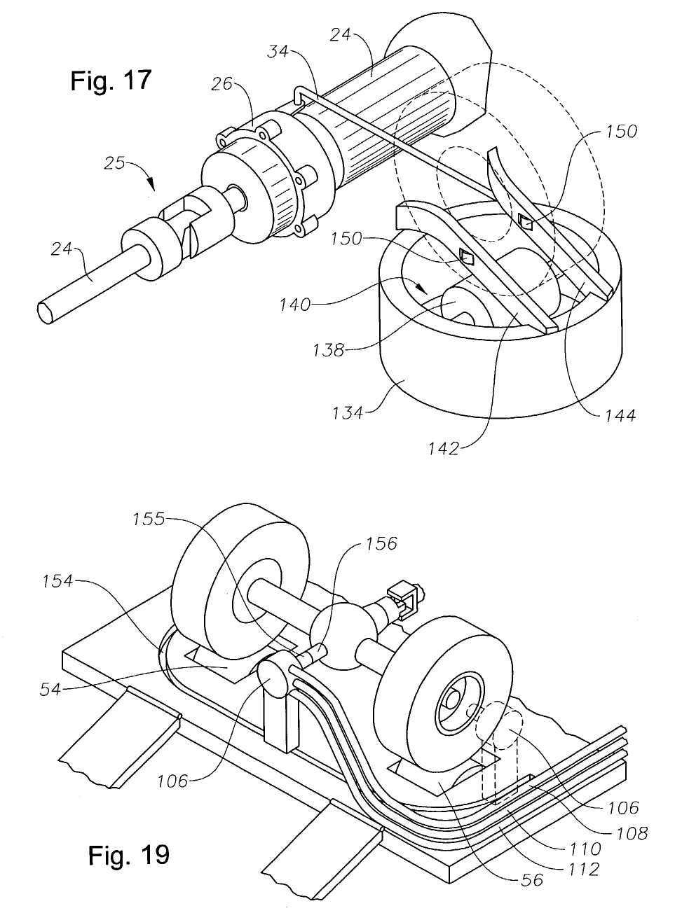

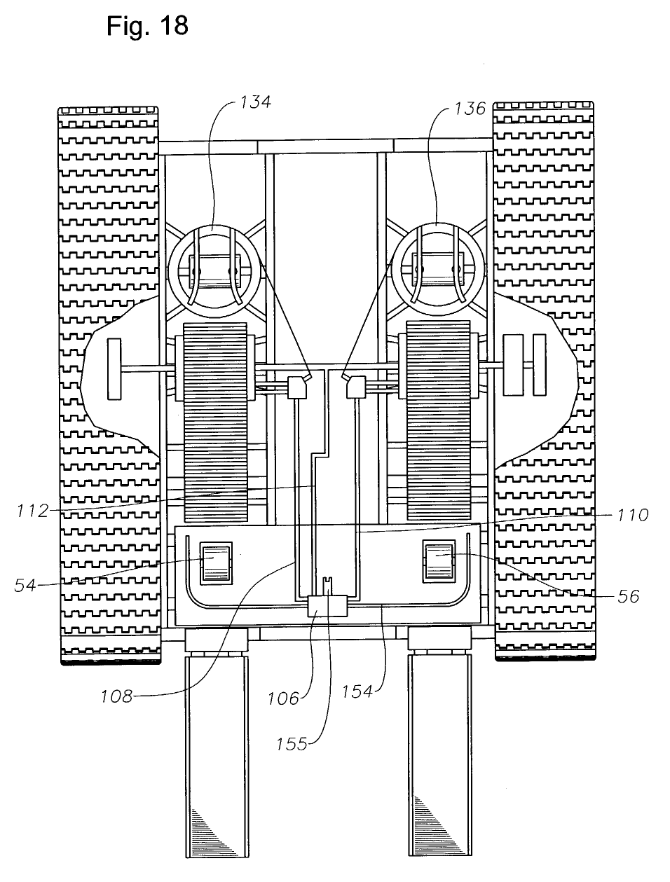

Referring now to FIGS. 18 and 19, this aspect of the present invention may also be incorporated into a hydraulically-powered embodiment similar to the embodiments discussed above and illustrated in FIGS. 12 and 13. In this embodiment, the hydraulic pump 106 may be movably disposed in a track 154 and adapted (such as by a sleeve 155) for removable attachment to a power-take-off (PTO) 156 on the vehicle (e.g., the four-wheeler 148). The conduits 108/110/112 may be connected to the corresponding components in the same manner as discussed above in connection with FIGS. 12 and 13. In this embodiment, the track apparatus may be provided with single rollers 54 and 56 in the same manner as discussed above in connection with FIG. 5, except that, in this specific embodiment, the rollers 54/56 are not connected to a gear drive or drive shaft but instead act as idler rollers. In using this embodiment, the pump 106 is moved along the track 154 to a side position (such as shown in phantom lines in FIG. 19) and the vehicle is driven onto the apparatus in the same manner as previously discussed. The pump 106 is then moved along the track 154 and positioned so that the sleeve 155 may be engaged with the PTO 156 in a manner known in the art. Once connected, the PTO 156 powers the pump 106 which in turn powers the motors 102 and 104. All other aspects of this embodiment, including its mode of operation, are as explained above in connection with the embodiments of FIGS. 12 and 13.

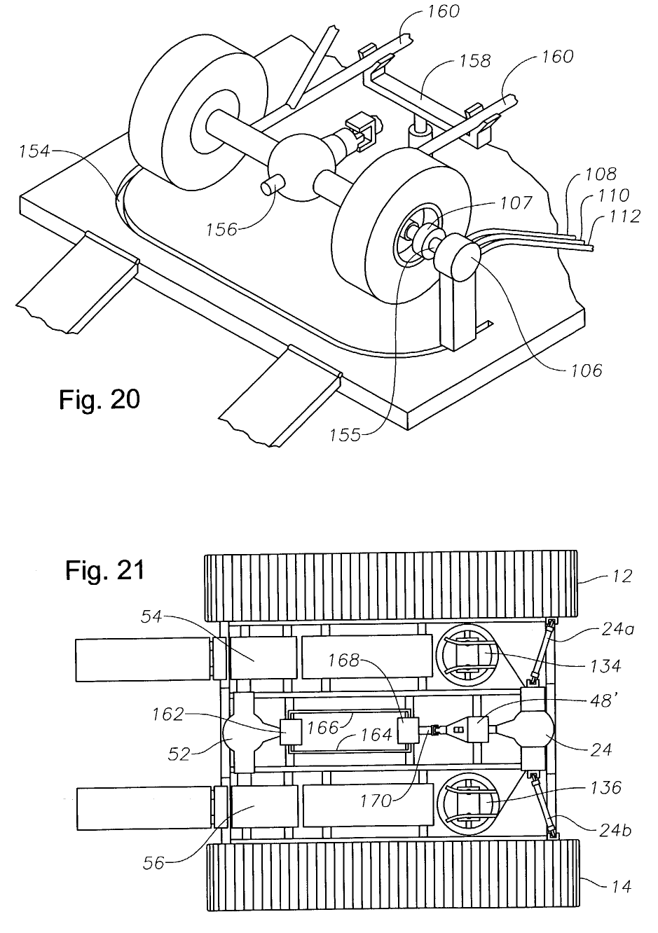

A variation of the embodiment shown in FIGS. 18 and 19 is shown in FIG. 20. In this embodiment, instead of engaging the rear drive wheels of the vehicle with the roller members 54 and 56, a jacking device 158 is provided to engage and lift the vehicle frame 160 such that the rear tires of the vehicle are lifted away from and not in contact with the track apparatus. As such, in this embodiment, there is no need for roller members 54 or 56. Further, in this embodiment, the pump 106 is shown engaged with one of the rear drive wheels of the vehicle, such as through sleeve 155. Alternatively, the pump 106 may be engaged with the PTO 156 in the same manner as discussed above in connection with FIG. 19. Similarly, in the embodiment shown above in FIG. 19, the pump 106 may be engaged with one of the rear drive wheel in the same manner as discussed in connection with FIG. 20. All other aspects of this embodiment are as explained above in connection with FIGS. 18 and 19.

Referring now to FIG. 21, another hydraulically-operated embodiment of the present invention is shown, in which a power generator 162 (such as a hydraulic pump) is connected to the output of the gear drive 52. The power generator 162 may include a high pressure conduit 164 in fluid communication with an inlet port of a hydraulic motor 168, and a return conduit 166 in fluid communication with an outlet port of the motor 168, in a manner understood by those of skill in the art. The motor 168 is adapted to deliver power to the transmission 48′ through an output shaft 170. Power is transmitted to the drive axle 24 to power the left and right track assemblies 12 and 14 in the same manner as discussed above, for example, in connection with FIG. 1. This embodiment of the track apparatus of the present invention is steered through the steering pads 134 and 136 in the same manner as discussed above in connection with FIG. 1. While this specific embodiment is shown with steering pads 134 and 136 of the type described above in connection with FIGS. 15-17 (i.e., for use with four-wheel drive vehicles), the present invention also includes an embodiment of the type shown in FIG. 21 used with steering pads 38 and 40 of the type discussed above, for example, in connection with FIG. 1. In operation, this embodiment is powered by placing drive wheels of a vehicle on the roller members 54 and 56, which cause the gear drive 52 to turn, which actuates the power generator 162, which actuates the motor 168, which causes the output shaft 170 to turn and deliver power to the track assemblies 12 and 14 in the manner discussed above.

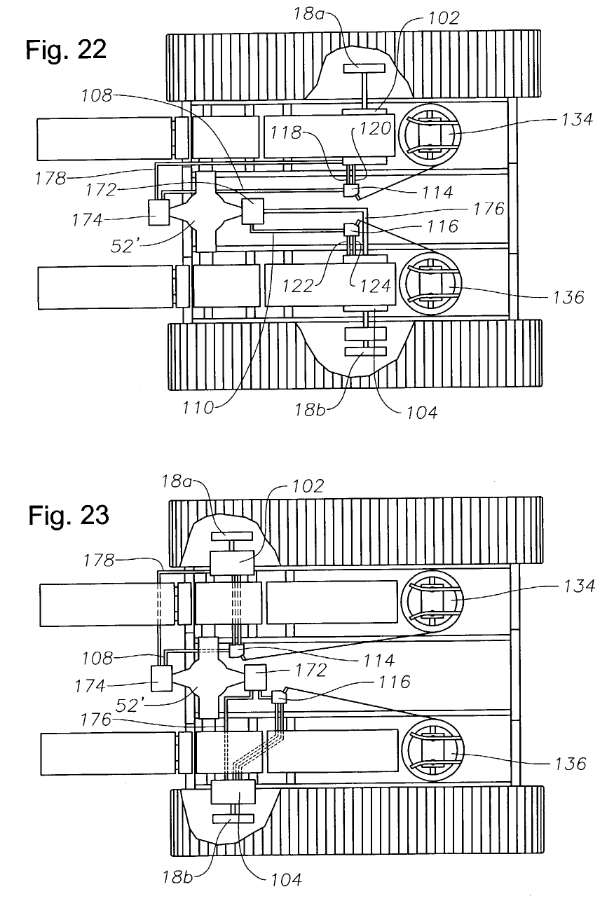

Another hydraulically-operated embodiment of the present invention is shown in FIG. 22. This embodiment is similar to the embodiment shown in FIG. 12, with the main difference being that the embodiment of FIG. 22 includes a first and a second power generator 172 and 174 (e.g., hydraulic pumps) as opposed to just one power generator 106, as shown in FIG. 12. From FIG. 22 it can be seen that the first power generator 172 is connected to a front side of the gear drive 52′ and the second power generator 174 is connected to a rear side of the gear drive 52′. In this regard, note that the gear drive 52′ includes two outputs whereas the gear drive 52 discussed above included only one output. The first generator 172 is in fluid communication with, and adapted to control operation of, the right hydraulic motor 104 through high pressure conduit 110, valve 116, conduits 122 and 124, and return conduit 176, in the same manner as discussed above in connection with FIG. 12. Similarly, the second generator 174 is in fluid communication with, and adapted to control operation of, the left hydraulic motor 102 through high pressure conduit 108, valve 114, conduits 118 and 120, and return conduit 178, in the same manner as discussed above in connection with FIG. 12. This embodiment of the track apparatus of the present invention is steered through the steering pads 134 and 136 in the same manner as discussed above in connection with FIG. 12. While this specific embodiment is shown with steering pads 134 and 136 of the type described above in connection with FIGS. 15-17, the present invention also includes an embodiment of the type shown in FIG. 22 used with steering pads 38 and 40 of the type discussed above, for example, in connection with FIG. 12. Other than as noted above, the structure and operation of the embodiment shown in FIG. 22 is substantially as set forth and explained above in connection with FIG. 12.

Another hydraulically-operated embodiment of the present invention is shown in FIG. 23. This embodiment is quite similar to the embodiment shown in FIG. 22, with the main difference being that the motors 102 and 104 and associated drive members 18a and 18b are situated towards the rear of the apparatus. All other aspects of this embodiment are substantially as set forth and explained above in connection with FIG. 22.

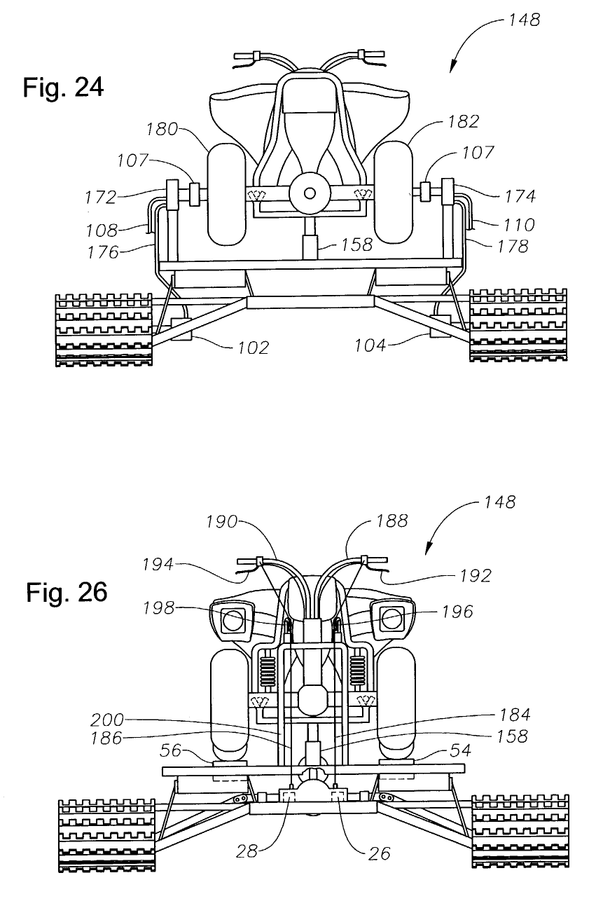

In another embodiment, as shown in FIG. 24, the pumps 172 and 174 may be connected to the left and right rear drive wheels 180 and 182, respectively, with final drives 107 disposed therebetween in the same manner as discussed and shown above in FIG. 20. In this embodiment, as with the embodiment shown in FIG. 20, the rear tires of the four-wheeler are raised and held up through the jacking device 158. Power is then transferred from the rear tires to the pumps 172 and 174, which in turn powers the motors 102 and 104 through conduits 108, 110, 176 and 178 in the same manner as discussed above in connection with the embodiments shown in FIGS. 22 and 23. While not shown in FIG. 24, this embodiment may be provided with steering pads 134 and 136 that are engaged with the front tires of the four-wheeler and connected to valves 114 and 116 as shown in FIGS. 22 and 23. The manner of operation of this embodiment is as explained above with regard to FIGS. 22 and 23. Alternatively, the valves 114/116 may be controlled via cables connected to the handlebars of the four-wheeler, in the manner described in the following paragraph.

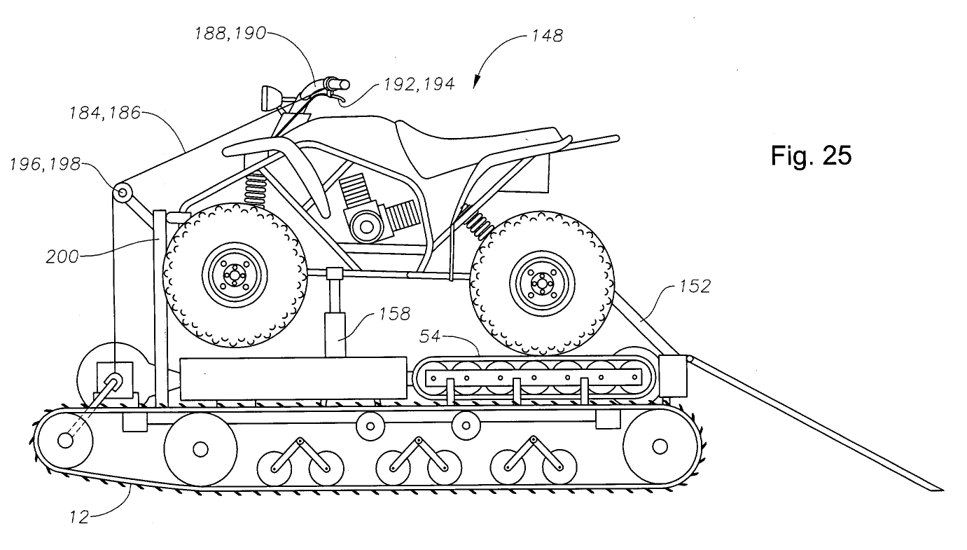

In another aspect of the present invention, as shown in FIGS. 25 and 26, instead of providing the steering function through steering pads, the front wheels of the four-wheeler 148 are raised up by a jacking device 158 and the steering function may be provided through cables 184 and 186. As best shown in FIG. 26, in a specific embodiment, the cables 184/186 may be connected on one end to brakes 26 and 28 in the same manner as discussed above, for example, in connection with FIG. 1, and on the other end to the handlebars 188 and 190. More particularly, the upper ends of the cables 184 and 186 may be tied into the brake cables provided with the four-wheeler 148 and operated by the brake levers 192 and 194 mounted on the handlebars 188/190, or they may be separately attached to the handlebars 188/190. In a specific embodiment, the cables 184/186 may be of the same type as the brake cables provided as standard equipment on the four-wheeler 148. In a specific embodiment, the cables 184/186 may be passed around pulleys 196/198 mounted to a support member 200 (which may also function as front attachment member 152 as shown in FIG. 16). This embodiment is then steered by squeezing the brake levers 192/194 or otherwise maneuvering the cables 184/186 to control the brakes 26/28 in the same manner as discussed above in connection with FIG. 1, for example. As best shown in FIG. 25, power is transferred from the rear drive wheels of the vehicle 148 through the roller members 54/56 to the track assemblies 12/14 in the same manner as discussed above, for example, in connection with FIG. 2. This embodiment may be used with any of the other aspects of the present invention described above in connection with FIGS. 1-23.

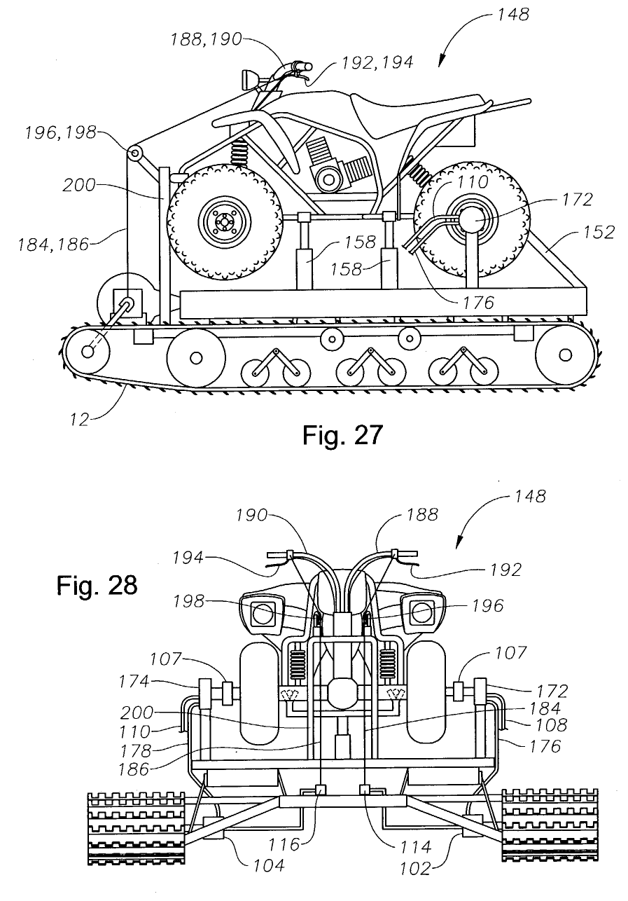

Referring now to FIGS. 27 and 28, another embodiment of the present invention is shown that is similar to the embodiment shown in FIGS. 25 and 26. The main differences between the two embodiments are: (1) in FIGS. 25/26, the brake cables 184/186 steer the apparatus by controlling brakes 26/28 and power is transferred from the drive wheels of the four-wheeler to the track assemblies 12/14 through some means of mechanical transmission; and (2) in FIGS. 27/28, the brake cables 184/186 steer the apparatus by controlling valves 114/116, which in turn controls motors 102/104, and power is hydraulically transferred from the drive wheels of the four-wheeler to the track assemblies through one or more power generators and associated conductors (e.g., fluid conduits). In a specific embodiment, the front tires of the four-wheeler 148 may be raised up by a jacking device 158, and the rear tires of the four-wheeler 148 may also be raised up by a jacking device 158, depending on which configuration is used to power one or more pumps. For example, as shown in FIGS. 27 and 28, the rear tires are raised up by a jacking device 158, and pumps 172/174 are connected to and powered by the rear wheels of the four-wheeler 148 in the same manner as explained above in connection with FIGS. 20 and 24. Alternatively, the motors 102/104 may be powered from a PTO 156 through a single pump 106, such as shown in FIG. 19, either with the rear wheels raised up or in contact with idler rollers 54/56. Alternatively, the rear wheels may be in contact with rollers 54/56 that are connected to a pump, such as shown in FIGS. 12, 13, 21, 22, and 23. The front tires may also be in contact with front idler roller members such as those shown and discussed in FIGS. 18 and 19, as opposed to being raise up by the jacking device 158.

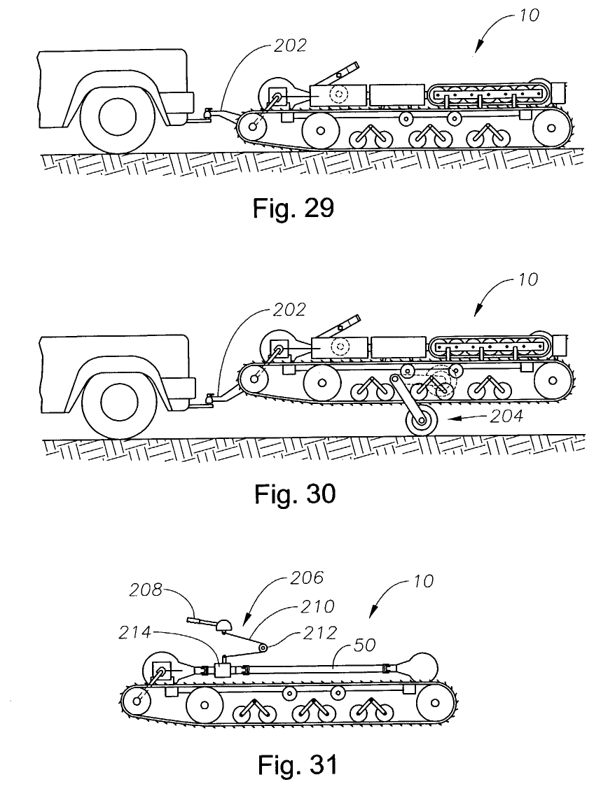

In another aspect, as shown in FIGS. 29 and 30, any of the above-discussed embodiments may include a trailer hitch 202 of a type known in the art. In the embodiment shown in FIG. 29, the transmission of the apparatus 10 may be shifted into neutral so that the apparatus may be pulled behind a towing vehicle, such as the vehicle 16. Alternatively, as shown in FIG. 30, the apparatus 10 may include a retractable towing wheel assembly 204 that includes a lowered, or towing, position and a raised position, which is shown in dashed lines. In this embodiment, the apparatus 10 may be raised up from the road surface to prevent wear on the track assemblies during transit. As shown in FIG. 31, the apparatus 10 may further include a parking brake assembly 206 which may include brake lever 208 connected to a brake cable 210 that may pass around a brake pulley 212 and connect to a brake 214 attached to the drive shaft 50.

It is to be understood that the invention is not limited to the exact details of construction, operation, exact materials or embodiments shown and described, as obvious modifications and equivalents will be apparent to one skilled in the art. For example, the scope of the invention is not intended to be limited to any particular type of track assembly 12 or 14, drive axle 24, brake 26, transmission 48, gear drive 52, hydraulic motor 102 or 104, power generator 106, or control device 114 or 116. Accordingly, the invention is therefore to be limited only by the scope of the appended claims.

1. A vehicular powered track apparatus comprising:
a left track assembly and a right track assembly, the left track assembly having a left drive member, and the right track assembly having a right drive member;
a left roller member connected to the left drive member, and a right roller member connected to the right drive member; and
a left steering pad operatively connected to the left drive member to control movement thereof, and a right steering pad operatively connected to the right drive member to control movement thereof, each steering pad having an idler roller rotatably mounted thereto.

2. The apparatus of claim 1, wherein each steering pad further includes a pair of retention members.

3. The apparatus of claim 2, wherein each retention member includes a side wall roller member rotatably mounted thereto.

4. The apparatus of claim 2, wherein each retention member includes a fixed end attached to its corresponding steering pad and an unattached end, and each retention member extends upwardly away from its fixed end at an inclined angle.

5. The apparatus of claim 1, further including a left brake operatively connected to the left steering pad and disposed to control transfer of rotational movement from the left roller member to the left drive member, and a right brake operatively connected to the right steering pad and disposed to control transfer of rotational movement from the right roller member to the right drive member.

6. The apparatus of claim 1, further including a left motor operatively connected to the left steering pad and disposed to control transfer of rotational movement from the left roller member to the left drive member, and a right motor operatively connected to the right steering pad and disposed to control transfer of rotational movement from the right roller member to the right drive member.

7. The apparatus of claim 1, further including at least one power generator connected to at least one of the left and right roller members, the power generator being in communication with at least one motor coupled to at least one of the left and right drive members.

8. A vehicular powered track apparatus comprising:
a left track assembly and a right track assembly, the left track assembly having a left drive member, and the right track assembly having a right drive member;
a left motor connected to the left drive member, and a right motor connected to the right drive member;
a left steering device operatively connected to a left control device, and a right steering device operatively connected to a right control device; and
at least one power generator in communication with the left motor through the left control device and with the right motor through the right control device.

9. The apparatus of claim 8, wherein the left steering device is a left steering pad, and the right steering device is a right steering pad.

10. The apparatus of claim 9, wherein each steering pad includes an idler roller rotatably mounted thereto.

11. The apparatus of claim 10, wherein each steering pad further includes a pair of retention members, and each retention member includes a side wall roller member rotatably mounted thereto.

12. The apparatus of claim 8, wherein the left steering device is a left cable, and the right steering device is a right cable.

13. The apparatus of claim 8, wherein the left control device is a left brake, and the right control device is a right brake.

14. The apparatus of claim 8, wherein the left control device is a left valve, and the right control device is a right valve.

15. The apparatus of claim 8, wherein the power generator is a pump movably disposed in a track and adapted for releasable engagement with a power-take-off device.

16. The apparatus of claim 8, wherein the at least one power generator comprises a left and a right pump, the left pump being in communication with the left motor through the left control device and the right pump being in communication with the right motor through the right control device.

17. A vehicular powered track apparatus comprising:
a left track assembly and a right track assembly, the left track assembly having a left drive member, and the right track assembly having a right drive member;
a left roller member connected to the left drive member, and a right roller member connected to the right drive member; and
a left cable operatively connected to the left drive member to control movement thereof, and a right cable operatively connected to the right drive member to control movement thereof, the vehicle being positioned on the apparatus such that front tires of the vehicle are not in contact with any part the apparatus other than, if any contact, with a rotating part thereof.

18. The apparatus of claim 17, further including a left brake operatively connected to the left cable and disposed to control transfer of rotational movement from the left roller member to the left drive member, and a right brake operatively connected to the right cable and disposed to control transfer of rotational movement from the right roller member to the right drive member.

19. The apparatus of claim 17, further including a left motor operatively connected to the left cable and disposed to control transfer of rotational movement from the left roller member to the left drive member, and a right motor operatively connected to the right cable and disposed to control transfer of rotational movement from the right roller member to the right drive member.

20. The apparatus of claim 17, further including at least one power generator connected to at least one of the left and right roller members, the at least one power generator being in communication with at least one of the left and right motors.

21. The apparatus of claim 17, wherein the left and right roller members are idler rollers.

22. A vehicular powered track apparatus comprising:
a left track assembly and a right track assembly, the left track assembly having a left drive member, and the right track assembly having a right drive member;
at least one power generator connected between a source of rotational power on the vehicle and the left and right drive members; and
a connector disposed between at least one component of the vehicle and the at least one power generator such that a direction of movement of the apparatus is controlled by movement of the at least one component of the vehicle.

23. The apparatus of claim 22, wherein the at least one power generator is at least one of a pump and a roller member.

24. The apparatus of claim 22, wherein the source of rotational power is a wheel on the vehicle.

25. The apparatus of claim 24, wherein the rotational power is transferred from the wheel to the power generator through a roller member.

26. The apparatus of claim 24, further including an idler roller member engaged with the wheel.

27. The apparatus of claim 24, further including a final drive connected between the wheel and the at least one power generator.

28. The apparatus of claim 22, further including a jacking device to raise the vehicle so that the only contact between the wheel and the apparatus is through the power generator.

29. The apparatus of claim 22, wherein the source of rotational power is a power-take-off on the vehicle.

30. The apparatus of claim 22, wherein the at least one component on the vehicle comprises the left front tire and the right front tire of the vehicle, and the connector comprises a left steering pad engageable with the left front tire and a right steering pad engageable with the right front tire.

31. The apparatus of claim 30, wherein the left steering pad is connected to a left control device adapted to control transmission of energy from the at least one power generator to a left motor connected to the left drive member, and the right steering pad is connected to a right control device adapted to control transmission of energy from the at least one power generator to a right motor connected to the right drive member.

32. The apparatus of claim 22, wherein the at least one component of the vehicle comprises a left brake lever and a right brake lever, and the connector comprises a left cable and a right cable, the left cable being connected between the left brake lever and a left control device adapted to control transmission of energy from the at least one power generator to the left drive member, and the right cable being connected between the right brake lever and a right control device adapted to control transmission of energy from the at least one power generator to the right drive member.

33. The apparatus of claim 22, wherein the at least one power generator is a pump movably disposed in a track.

34. The apparatus of claim 22, further including a gear drive connected between a left roller member and a right roller member, and further being connected to a first pump and a second pump, the first pump being in communication with a left motor connected to the left drive member, and the second pump being in communication with a right motor connected to the right drive member.

35. A vehicular powered track apparatus comprising:
a left track assembly and a right track assembly, the left track assembly having a left drive member, and the right track assembly having a right drive member;
means for transferring movement from a wheel of the vehicle to the left and right drive members; and
means for controlling movement of the left and right drive members.
